(19) United States
(12) Patent Application Publication
(10) Pub. No.: US 2012/0207905 A1
(43) Pub. Date: Aug. 16, 2012

(54) EFFICIENT DRYING OF MOLDED ANIMAL CHEWS

(75) Inventor: Glen S. AXELROD, Colts Neck, NJ (US)

(73) Assignee: T.F.H. PUBLICATIONS, INC., Neptune City, NJ (US)

(21) Appl. No.: 13/026,721

(22) Filed: Feb. 14, 2011

(51) Int. Cl. A23K 1/18; A23P 1/12; A23L 1/0522

(52) U.S. Cl. 426/560; 426/456; 426/464

(57) ABSTRACT

A method of relatively rapidly and uniformly extracting moisture from an animal chew having an edible composition is provided. Process cycle time and scrap levels may be reduced and the level of uniformity in the animal chew may be improved by including one or more openings selectively sized and positioned in the chew prior to drying.

### FIELD

This disclosure relates to edible pet chews formed by molding and more particularly, to a method of drying such pet chews, after molding, that reduces cycle time, cost and scrap rates. The pet chews may be configured with selected openings contained within the periphery of the chew to allow for more efficient rates of drying and removal of moisture.

### BACKGROUND

Most dogs enjoy chewing on things although preferences may vary as to the hardness of the substances favored. Some dogs may like to chew on very hard materials such as cow bones, wood, nylon or polyurethane, while others may prefer softer chews such as rawhide, and starch-based compositions. Some dogs, due to their age, may not be able to chew on the hard substances. Young dogs have insufficiently developed teeth, while old dogs may have diseased gums or may have lost some of their teeth.

The field of animal chews has also developed wherein a number of disclosures have been directed at those types of chews that may be characterized as edible based compositions. For example, attention is directed to the following U.S. patents, commonly owned by the assignee herein: U.S. Pat. No. 5,476,069 entitled “Molded Rawhide Chew Toy”; U.S. patent application Ser. No. 08/923,070 filed Sep. 3, 1997 entitled “Vegetable Based Dog Chew” now U.S. Pat. No. 6,093,427; U.S. patent application Ser. No. 08/738,423 filed Oct. 25, 1997 entitled “Edible Dog Chew” now U.S. Pat. No. 5,827,565; U.S. patent application Ser. No. 08/784,834 filed Jan. 17, 1997 entitled “Carrot-Based Dog Chew” now U.S. Pat. No. 5,941,197; U.S. patent application Ser. No. 09/114,872 filed Jul. 14, 1998 entitled “Heat Modifiable Edible Dog Chew” now U.S. Pat. No. 6,180,161; U.S. patent application Ser. No. 09/138,804 filed Aug. 21, 1998 entitled “Improved Edible Dog Chew” now U.S. Pat. No. 6,126,978; U.S. patent application Ser. No. 09/116,070 filed Jul. 15, 1998 entitled “Wheat & Casein Dow Chew With Modifiable Texture” now U.S. Pat. No. 6,110,521; U.S. patent application Ser. No. 09/116,555 filed Jul. 15, 1998 entitled “Heat Modifiable Peanut Dog Chew” now U.S. Pat. No. 6,093,441; U.S. patent application Ser. No. 09/227,767 filed Jan. 8, 1999 entitled “Method of Molding Edible Starch” now U.S. Pat. No. 6,159,516.

### SUMMARY

A method of forming animal chews, comprising providing an edible composition, the edible composition including water, providing melt processing equipment to process the edible composition, processing the edible composition through the melt processing equipment to form a shaped animal chew, the shape having a thickness, an outer periphery and an upper surface, the upper surface spanning the periphery and having a greatest linear dimension, wherein the formed shape includes one or more openings. This may be followed by drying the formed shape to a desired water level, wherein at least one of the one or more openings has an inner periphery and a distance from the inner periphery to the outer periphery of the shaped animal chew is less than one-half the greatest linear dimension.

### BRIEF DESCRIPTION OF THE DRAWINGS

The features, operation and advantages of the invention may be better understood from the following detailed description of the preferred embodiments taken in conjunction with the attached drawings, in which

FIGS. 1A-1F are perspective views of some different shapes of animal chews that may be molded;

FIG. 2 is a schematic of a generic shape of animal chew illustrating the moisture levels after a period of drying;

FIG. 3 is a plan view of an animal chew according to the present disclosure which includes openings for achieving a more uniform moisture level after drying;

FIG. 4 is a process flow chart for molding animal chews.

### DETAILED DESCRIPTION

Still other objects and advantages of the present invention will become readily apparent to those skilled in the art from the following detailed description, wherein it is shown and described preferred embodiments of the invention. As will be realized the invention is capable of other and different embodiments, and its several details are capable of modification in various respects, without departing from the invention. Accordingly, the description is to be regarded as illustrative in nature and not as restrictive.

Animal chews, particularly those made with edible resins and having a desired residual level of moisture, may generally be formed into a shape by melt processes such as injection molding and extrusion. Once the composition has been formed to shape it may need to be dried to a desired level of moisture for packaging such that the chew is fresh and palatable when given to the animal for enjoyment.

“Edible” resins or compositions as used herein refer to any resins or compositions which are digestible by an animal and in addition provide some nutritional value. Examples of such may include starch based formulations. More specifically, the edible resin in may include any starch or carbohydrate of natural or vegetable origin or gluten, such as wheat gluten. Exemplary starches may include amylose and/or amylopectin and may be extracted from plants, including but not limited to potatoes, rice, tapioca, corn and cereals such as rye, wheat, and oats. The starch may preferably be present in the resin composition between about 30-99%.

The starch employed may preferably be raw starch, which may be understood as starch that has not seen a prior thermal molding history, such as extrusion or other type of melt processing step where the resin is shaped in the presence of heat. The raw starch itself may also be native, which may be understood as unmodified starch recovered in the original form by extraction and not physically or chemically modified. It should be understood that the raw starch may also have varying degrees of moisture present.

The compositions may further include gluten. Gluten may be understood as water-insoluble protein complex extracted from cereal grains such as maize or corn and wheat.

Accordingly, the present invention contemplates the use of a wheat gluten material either as the base resin or in combination with another edible resin, such as starch. The resin may also include or be based upon cellulose.

Emulsifiers or surfactants may also be incorporated into the resin composition. The emulsifier may include, for example, lecithin, which may be extracted or derived from egg yolk or soy beans. The resin composition may also include a plasticizer. The plasticizer may include for example, glycerin. The resin composition may include a nutraceutical. The nutraceutical may be fermented soya. A humectant may also be incorporated into the resin composition. The humectant may include, for example, oat fiber. A humectant may be understood to be any additive that may absorb water in the material.

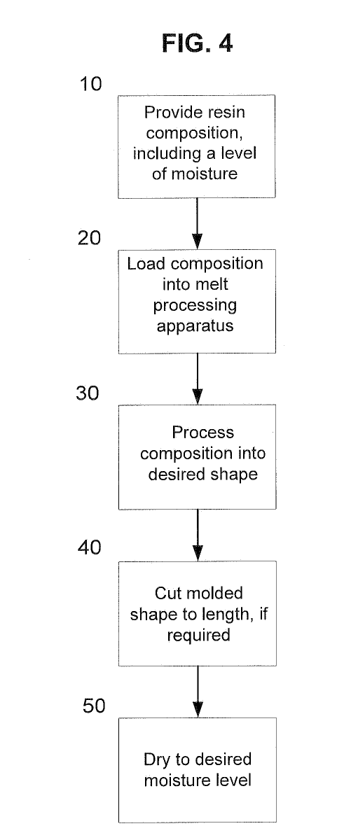

FIG. 4 is a flow chart indicating a general process for the forming of animal chews. The chart may apply to the injection molding or extrusion of resin compositions which include water, or other liquid ingredients. A resin composition may be provided (Block 10) which may include, for instance, 10-40% moisture as well as other liquid ingredients (humectants, flavorings, colorings, etc.) The composition may be mixed prior to or after loading into the barrel (Block 20) of a melt processing apparatus, such as an extruder or an injection molding machine. The composition may then be processed through the apparatus and formed into a desired shape (Block 30). Forming may occur to final shape in a closed mold or into an extrudate which may be cut to length (Block 40). The formed/cut chews may then be exposed to a drying process (Block 50), for instance 60° F. and higher for 2 hours to provide the desired level of moisture in the final chew, preferably less than or equal to 15.0% by weight moisture, or in the range of 1.0% to 15.0% by weight moisture. Accordingly, drying may be carried out at temperatures from 60° F. to 200° F.

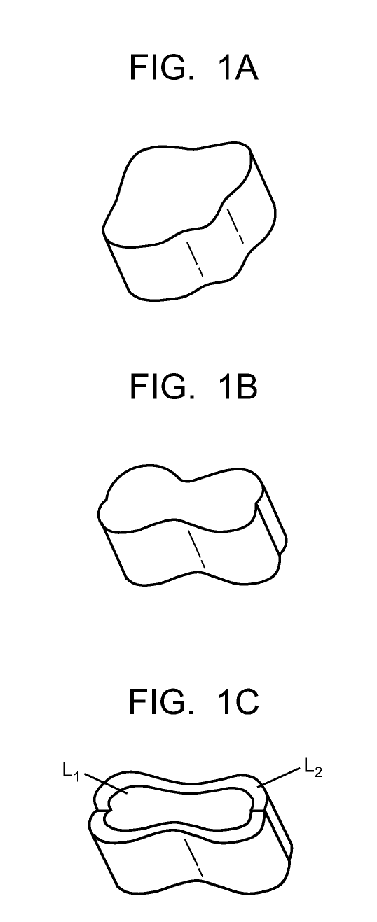

FIGS. 1A-1F illustrate a number of different shapes that may be of interest to an animal. FIG. 1A illustrates a dog chew that may resemble a meat “chop”. FIG. 1B illustrates a dog chew that may resemble a dog bone. FIG. 1C illustrates a shape for a chew toy having two layers, L₁ and L₂, each having a different composition and, optionally, a different level of moisture when formed. This may further complicate the drying process where one layer, L₂, may be dried excessively while layer L₁ may not be dried sufficiently under a given drying regimen. FIGS. 1D-1F illustrate other shapes for dog chews.

These chews generally have somewhat irregular shapes and may generally not be symmetrical and since the moisture level may be reduced during a drying process to a desired level, the chews may dry from the outside in. “Irregular shape” as used herein refers to a shape which lacks symmetry or evenness. Due to such irregular shape, the rate of drying may be different for different portions of a chew, depending on the distance to the periphery of the chew. It is desirable to provide chews with a uniform level of moisture across the chew and to complete the drying process in a minimal amount of time. Preferably, the chew toys may be about 1.5-2.0 inches (38.0 mm-50.8 mm) in largest dimension (width, length) and about 0.125-1.0 inches (3.18 mm-25.4 mm) thick, although other sizes are contemplated.

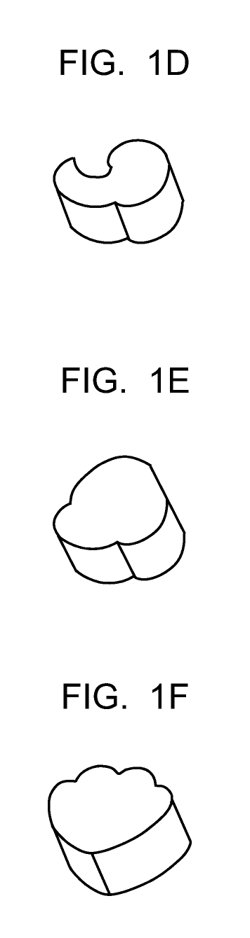

FIG. 2 is a schematic of an animal chew 500 illustrating the moisture levels present after an hour of drying at 60° F. As may be appreciated, it is now recognized that the moisture levels basically reside in bands that are substantially symmetrical with the shape of the periphery 502 of the chew 500. The result may be a chew that is relatively too dry near the periphery 100, for instance at 2% by weight moisture, where the center of the chew 300 may have a level of 20% by weight moisture, when the desired level is about 12% by weight moisture (200). This may then lead to uneven shrinkage, and/or cracking of the chew due to drying too fast and brittleness. It can be appreciated that the preferred shapes herein as shown in FIG. 2 may be substantially planar, meaning that they are of relatively constant thickness (i.e. thickness does not vary more than plus or minus 20% across the surface of the part).

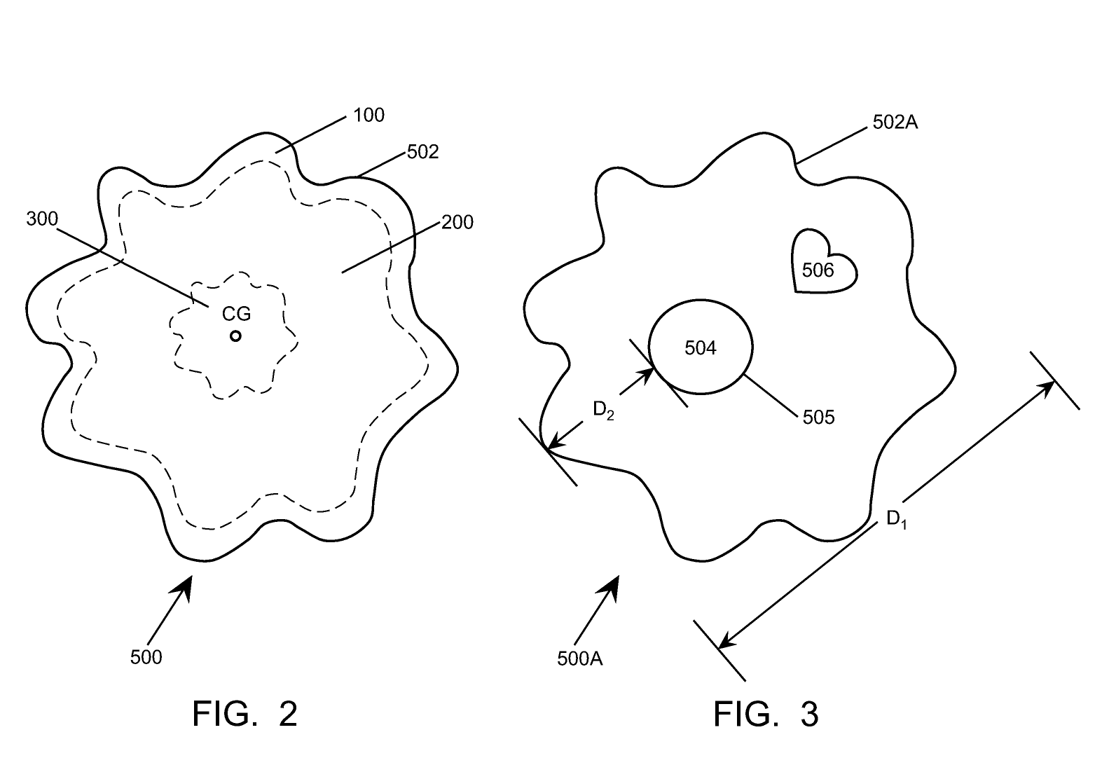

FIG. 3 illustrates a method for more efficiently drying a complex shape and providing a more uniform moisture content across the breadth of the chew 500A. Here, one or more openings 504, 506 are formed or cut into the cross-section of the chew. The openings may be formed during the forming to shape process either in the forming mold or the extrusion die. The openings may also be formed after molding to shape by cutting using, for instance, a die punch, laser, water jet, router, etc.

The openings 504, 506 may be sized to provide a relatively uniform moisture level after a period of exposure to an elevated temperature, based on the geometry of the formed chew 500. The openings 504, 506 may be located relative to the periphery and center of gravity (CG) of the chew 500 to provide a reduced duration for drying to the desired level to take place by minimizing the distance between the openings and between the openings and the periphery 502. In one exemplary embodiment, a distance D₂ from the edge or inner periphery 505 of the opening 504 to the periphery 502A is less than one-half of the largest dimension D₁ of the chew 500A (see FIG. 3).

“Greatest linear dimension” as used herein refers the longest linear dimension that can be drawn across the upper surface of a molded animal chew from one side of the periphery to the other. This may be a length, width or diagonal in the case of a relatively regular shape, or may connect any two points on the periphery that are the greatest distance apart. By placing an opening along that line, one effectively shortens the path for moisture to escape from the chew during the drying process, accelerating the process.

Any number of openings 504, 506 may be included in the chew from 1 to 20, and in all increments there-between, such as 1, 2, 3, 4, 5, etc.

The openings 504, 506 may preferably be of a closed shape and have relatively smooth inner peripheries. “Relatively smooth inner peripheries” as used herein refers to a shape having rounded or curved corners and devoid of a radius at any location of less than 1.0 mm. In such manner, upon shrinkage, stresses and potential cracking in the openings 504 or 506 may be reduced or avoided. However, it is contemplated that one may have a plurality of radii of greater than 1.0 mm in the openings.

Accordingly, the method of the present disclosure, by including one or more openings in the molded animal chew, may eliminate the portion of the chew that will dry to the desired moisture level last, allowing the chew to dry relatively more efficiently from the inside out, as well as from the outside in. Drying may therefore take place more rapidly as moisture will have a shorter path to travel to exit the chew. Because the drying process is now relatively more uniform, the stress and/or shrinkage will also be relatively more uniform and the chew will be less likely to crack. Further, with an opening placed near the center of gravity of the chew, shrinkage may take place with less likelihood of cracking as the opening will provide an area of stress relief.

While particular embodiments of the present disclosure have been illustrated and described, it would be obvious to those skilled in the art that various other changes and modifications can be made without departing from the spirit and scope of the disclosure. It is therefore intended to cover in the appended claims all such changes and modifications that are within the scope of this disclosure.

What is claimed is:

1. A method of forming animal chews, comprising:
a. providing an edible composition, said edible composition including water;
b. providing melt processing equipment to process said edible composition:
c. processing said edible composition through said melt processing equipment to form a shaped animal chew, said shape having a thickness, an outer periphery and an upper surface, said upper surface spanning said periphery and having a greatest linear dimension, wherein said formed shape includes one or more openings; and
d. drying said formed shape to a desired water level, wherein at least one of said one or more openings has an inner periphery and a distance from said inner periphery to said outer periphery of said shaped animal chew is less than one-half said greatest linear dimension.

2. The method of claim 1 wherein said edible composition includes starch.

3. The method of claim 1 wherein said desired water level is at or below 15.0% by weight of the chew.

4. The method of claim 1 wherein said melt processing equipment is an injection molding machine.

5. The method of claim 1 wherein said melt processing equipment is an extruder.

6. The method of claim 1 wherein said drying comprises exposure in an environment of 60° F. for 2 hours.

7. The method of claim 1 wherein said one or more openings are formed during the melt processing step.

8. The method of claim 1 wherein said one or more openings are formed in a subsequent step to the forming of said shape by the removal of a portion of said shape.

9. The method of claim 8 wherein said removal of a portion of said shape utilizes a laser, water jet, die punch or router.

10. The method of claim 1 wherein said one or more openings is devoid of any radii of less than 1.0 mm.

11. The method of claim 10 wherein said one or more openings have a plurality of radii of greater than 1.0 mm.

12. The method of claim 5 wherein said formed shape is an extrudate and said thickness is formed by cutting said extrudate at desired intervals.

13. An edible animal chew comprising:
a composition including starch and water at a level of 15.0% by weight or less in a configuration having a thickness, an outer periphery and an upper surface, said upper surface spanning said periphery and having a greatest linear dimension, wherein said configuration includes one or more openings and at least one of said one or more openings has an inner periphery and a distance from said inner periphery to said outer periphery is less than one-half said greatest dimension and wherein said thickness is in the range of 3.18 mm-25.4 mm, said one or more openings is devoid of any radii of less than 1.0 mm.

14. The animal chew of claim 12 wherein said one or more openings have a plurality of radii of greater than 1.0 mm.
